(19) United States
(12) Patent Application Publication
(10) Pub. No.: US 2023/0285954 A1
(43) Pub. Date: Sep. 14, 2023

(54) ELECTRIC HEATER

(71) Applicant: LUMMUS TECHNOLOGY LLC, Houston, TX (US)

(72) Inventors: William Scott Neifert, Houston, TX (US); Sunil Shashikant Panditrao, Houston, TX (US); Richard John Jibb, Houston, TX (US)

(73) Assignee: LUMMUS TECHNOLOGY LLC, Houston, TX (US)

(21) Appl. No.: 18/183,599

(22) Filed: Mar. 14, 2023

Related U.S. Application Data
(60) Provisional application No. 63/269,322, filed on Mar. 14, 2022.

(51) Int. Cl. B01J 38/12; B01J 8/02; H05B 3/00; F24H 3/04

(52) U.S. Cl. CPC B01J 38/12; B01J 8/0285; H05B 3/0052; F24H 3/0405; B01J 2208/00407; B01J 2208/00176; B01J 2208/00504; F24H 2250/02; H05B 3/12

(57) ABSTRACT

A process for regenerating a catalyst in an olefin production reactor. The process includes feeding a compressed, pre-heated air stream to a heating zone comprising an electrical heater, electrically heating the compressed, pre-heated air stream in the heating zone to a temperature in the range of 500-800° C., producing a regeneration air stream, feeding the regeneration air stream to the olefin production reactor, regenerating the catalyst using the regeneration air, producing a hot air stream, and feeding the hot air stream to a waste heat recovery unit configured to pre-heat a compressed air stream, producing the compressed, pre-heated air stream and a waste air stream.

### FIELD OF THE DISCLOSURE

Embodiments of the present disclosure generally relate to paraffin dehydrogenation units such as CATOFIN®. One of the modes of supplying heat of reaction is an air heater. Presently, plants primarily use fuel fired air heaters that lead to emissions associated with firing. This disclosure replaces the fired heater with an electric heater to reduce the fuel fired. With growing renewable energy availability, this may reduce greenhouse gas emissions of the CATOFIN® technology.

### BACKGROUND

WO2020245016A1 discloses one or more heat consuming processes (>500° C.), at least one of which is electrically heated. Products of heat consuming process are passed to energy carrier network with a capacity 5 GWh.

U.S. Pat. No. 9,908,091B2 discloses a furnace for steam reforming which includes at least one burner and at least one voltage source connected to reactor tubes. A current is passed through the reactor tubes to heat the feedstock.

US20210254774A1 discloses a steam reformer with a combustion chamber containing reactor tubes. A heating element is placed inside the reactor tubes.

US20210051770A1 discloses an electrically heatable solids packed apparatus for endothermic reactions including dehydrogenation of propane (listed, but not described in detail). The packed bed is divided into an upper, middle and lower sections which are electrically isolated. Heating is by means of electrodes installed in an electrically conductive solid state packing.

US20210171344A1 discloses a steam reforming reactor with a macroscopic structure supporting a catalyst coating. A current is passed through the macroscopic structure to heat part of the catalyst to >500° C.

### SUMMARY

In one aspect, embodiments disclosed herein relate to a process for regenerating a catalyst in an olefin production reactor. The process includes feeding a compressed, pre-heated air stream to a heating zone comprising an electrical heater, electrically heating the compressed, pre-heated air stream in the heating zone to a temperature in the range of 500-800° C., producing a regeneration air stream, feeding the regeneration air stream to the olefin production reactor, regenerating the catalyst using the regeneration air, producing a hot air stream, and feeding the hot air stream to a waste heat recovery unit configured to pre-heat a compressed air stream, producing the compressed, pre-heated air stream and a waste air stream.

In another aspect, embodiments disclosed herein relate to an electrical heater for heating an air stream. The electrical heater includes one or more electrical heating elements disposed in an electrically heated radiant section, one or more surface area increasing features attached to the one or more heating elements, a ceramic refractory material configured for adsorbing a radiant heat from the one or more electrical heating elements and transferring the heat to the air stream by convection, and one or more heating elements disposed in an electrically heated convention section, the electrically heated convection section located upstream of the electrically heated radiant section. The electrical heater is configured for heating the air stream to a temperature in the range of 500-800° C.

In yet another aspect, embodiments disclosed herein relate to a system for regenerating a catalyst in an olefin production reactor. The system includes a heating zone comprising an electrical heater configured for receiving a compressed, pre-heated air stream and electrically heating the compressed, pre-heated air stream to a temperature in the range of 500-800° C., producing a regeneration air stream, a flow line configured for feeding the regeneration air stream to the olefin production reactor, where the regeneration air stream regenerates the catalyst and produces a hot air stream, and a waste heat recovery unit configured to pre-heat a compressed air stream using the hot air stream, producing the compressed, pre-heated air stream and a waste air stream.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 illustrates a simplified process flow diagram of systems and processes according to one or more embodiments disclosed herein.

FIG. 2 illustrates a simplified process flow diagram of systems and processes according to one or more embodiments disclosed herein.

FIG. 3(A-G) illustrates a simplified process flow diagram of systems and processes according to one or more embodiments disclosed herein.

FIG. 4 illustrates a simplified process flow diagram of systems and processes according to one or more embodiments disclosed herein.

FIG. 5 illustrates a simplified process flow diagram of systems and processes according to one or more embodiments disclosed herein.

FIG. 6 illustrates a simplified process flow diagram of systems and processes according to one or more embodiments disclosed herein.

FIG. 7 illustrates a simplified process flow diagram of systems and processes according to one or more embodiments disclosed herein.

### DETAILED DESCRIPTION

It has now been found that a particularly suitable way of electrical heating can be provided when the at least one heating element is a resistance based heating element. Electric resistance heating is a well-known method of converting electrical power into heat. This technology is used in many other industrial applications. High temperature (>1000° C.) resistance heating is, for example, used in the glass industry, metal industry and many laboratory installations. When considering an isolated system, converting power to heat by means of resistance heating is near 100% efficient. Resistance heating takes place by means of the “Joule effect”. Joule's first law states that the power (P) of heating generated by an electrical conductor is proportional to the product of its resistance and the square of the current (P=I²R, wherein I is the current and R is the resistance).

Many different types of electrical resistance heating elements exist, each having their specific application purpose. As an example, mineral insulated wire technology may be used for certain applications, however use thereof is limited.

Nickel-chromium (NiCr) heating elements are used in many industrial furnaces and electric household appliances. The material is robust and repairable (weldable), available at medium costs and in various grades. However, the use of NiCr is limited by a maximum operating temperature at 1100° C., considering the lifetime of the heating elements.

Another option for use in the reactor configuration and the high temperature application of the present disclosure are silicon carbide (SiC) heating elements. SiC heating elements can achieve temperatures up to 1600° C. and may have large diameters (commercially available up to 55 mm) allowing a high heating duty per element. In addition, the costs of SiC heating elements are relatively low.

One or more embodiments for electrical heating elements may be MoSi2 or FeCrAl based resistance heating elements.

Molybdenum disilicide (MoSi2) elements have the ability to withstand oxidation at high temperatures. This is due to the formation of a thin layer of quartz glass on the surface. A slightly oxidizing atmosphere (>200 ppm O2) is needed to maintain the protective layer on the elements. After having been in operation the elements become very brittle in cold conditions and thus are easily damaged. The MoSi2 heating elements are available in various grades up to 1850° C., allowing use in a large range of high temperature gas conversion processes. The electric resistivity of the elements is a function of temperature. However, the resistance of these elements does not change due to aging. Only a slight reduction in resistance occurs during the first use period. Consequently, failed elements can be replaced without having impact on the other connected elements when installed in series. An advantage of MoSi2 elements is the high surface loading of up to 35 W/cm2.

Another alloy which may be used is FeCrAl (Fecralloy). FeCrAl resistance wire is a robust heating technology. The duty can be controlled by means of relatively simple on/off control. Theoretically, high voltages can be applied to deliver the heating duty. However, this is not commonly applied as it puts extra load on the electrical switches and requires suitable refractory material to provide sufficient electrical insulation. Fecralloy heating elements have favorable lifetime and performance properties. It is capable of operating at relatively high temperature (up to about 1300° C.) and has a good surface load (5 W/cm2). In some embodiments, Fecralloy heating elements are used in an oxidizing atmosphere (>200 ppm O2) to maintain an Al2O3 protective layer on the elements.

Embodiments herein are directed toward novel large industrial air heaters for use in various processes, including but not limited to the following examples: CATOFIN® and CATADIENE® dehydrogenation technologies, catalyst regeneration systems requiring hot air, regenerative heat exchangers (processes where heat is stored in thermal storage medium, e.g., rocks, salt, etc.).

Embodiments herein are also directed toward processes and systems that allow for the novel electric heaters to be applied to other processes with fluids other than air where it is desired to electrify heaters in effort to meet sustainability goals and reduce greenhouse gas emissions, or for other motives.

Government regulations, public pressure, and sustainability goals are driving petrochemical plants to reduce greenhouse gas emissions. One area of focus is on large scale electrical heaters vs. fired heaters. One or more embodiments herein may allow for a move to renewable energy sources rather than fossil fuels used in fired heaters. Embodiments may be applicable to new greenfield projects, but also as a retrofit where a site must reduce their greenhouse gas emissions to meet tightening regulations.

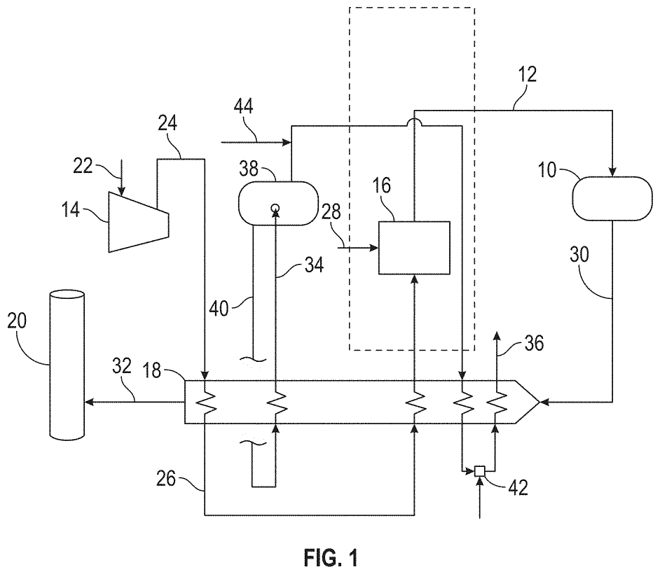

Refer to FIG. 1 for an overview of the current CATOFIN® reactor 10 regeneration air system. CATOFIN® reactor 10 requires hot regeneration air 12 at about 500-800° C. to burn coke off the catalyst and to heat the catalyst bed, which drives the dehydrogenation reaction. The process consists of air compressor(s) 14, a Fired Regeneration Air Heater 16, the CATOFIN® Reactors 10, a Waste Heat Recovery Exchanger 18, and a Stack 20. An air stream 22 is compressed to about 2.0-3.0 bar(a) to convey through the regeneration system. The compressed air 24 is then preheated in the Waste Heat Recovery Exchanger 18 to about 300-500° C. The preheated air 26 is fed back through the waste heat recovery exchanger 18 again and then heated in the Fired Regeneration Heater 16 to 600-800° C., ranging in heat absorbed from 30-300 MW, depending on the plant production rate and operating conditions, with a fuel source of hydrogen rich fuel 28 (a plant by-product) supplemented by natural gas and propane. The Fired Regeneration Air Heater effluent 12 then feeds the CATOFIN® reactors 10 where coke is burned and catalyst is heated to recover heat lost due to the endothermic dehydrogenation reaction. The heated air 30 then flows from the CATOFIN® reactors 10 to the Waste Heat Recovery Exchanger 18, where the air is cooled to about 80-120° C., producing a cool air stream 32. The cool air stream 32 then exits through the stack 20. The Waste Heat Recovery Exchanger 18 recovers energy from the CATOFIN® reactor air effluent 30, by preheating the compressed air 24, generating high pressure steam 34, and superheated high pressure steam 36 A knockout drum 38 feeds water 40 to the waste heat recovery exchanger 18 to produce mixed-phase steam via a thermosiphon design, which returns to the knockout drum 38. The high-pressure steam generated in 38 is then mixed with other high pressure steam sources 44 and sent to waste heat recovery exchanger 18 where it is superheated, then fed to desuperheater 42, then fed to waste heat recovery exchanger 18 where it produces superheated steam 36.

Note the CATOFIN® reactor 10 operates in a cyclic manner such that the dehydrogenation and regeneration/reheat occur at separate distinct times.

In the current CATOFIN® process, the fired heater 16 effluent 12 will contain some CO2 emissions due to combusting hydrocarbon fuels to heat air. To reduce CO2 emissions, the inventors conducted a search of available electric air heaters from major suppliers. The result of the study is as follows:

To electrically heat air to 600-800° C., air flows over electric element bundles. The elements may be NiCr resistive wire embedded in MgO insulation encased in a metal sheath. Discussed below is a summary of issues identified with the existing electric element bundles.

Many heaters would be required. Existing heaters are <5 MW scale, too small for use in a commercial olefins plant.

Total element length is very long resulting in poor heat transfer coefficient, and not being able to reach temperatures up to 800° C. Due to the element length, the total heater volume is also very large.

Overall, the element length, total heater volume required, and small scale of existing heaters makes them impractical for use in commercial scale olefin plants. The inefficient heat transfer and requirement for multiple heaters in series to achieve the required temperatures makes the cost and footprint for heating simply too large and undesirable.

The present inventors have designed electrical heaters that may be useful for electrically heating regeneration air for commercial olefin plants, among other large scale industrial uses. Integration of electric heaters according to embodiments herein results in reduced CO2 emissions for CATOFIN® units and enables a reduction in use of fossil fuels. Embodiments herein also overcome the main obstacle to electrifying commercial scale processes, notable the lack of a demonstrated design for the conditions required for a CATOFIN® heater reaching up to 800° C. at 30-300 MW scale. For example, electric heaters herein may be rated for transferring heat in the range from 30 to 300 MW, such as from a lower limit of 30, 50, 75, 100, or 150 MW to an upper limit of 150, 200, 225, 250, 275, or 300 MW, where any lower limit may be paired with any mathematically compatible upper limit.

Heaters according to various embodiments herein may be arranged as a single heater box containing the heating elements arranged and configured to provide the necessary heat to the air stream being heated. Due to the compact and efficient design outlined herein and illustrated in the figures, electric heaters according to embodiments herein may have a relatively low footprint area suitable for integration into commercial scale plants, especially as compared to the multiple-heater units required by the presently available (<5 MW) heaters.

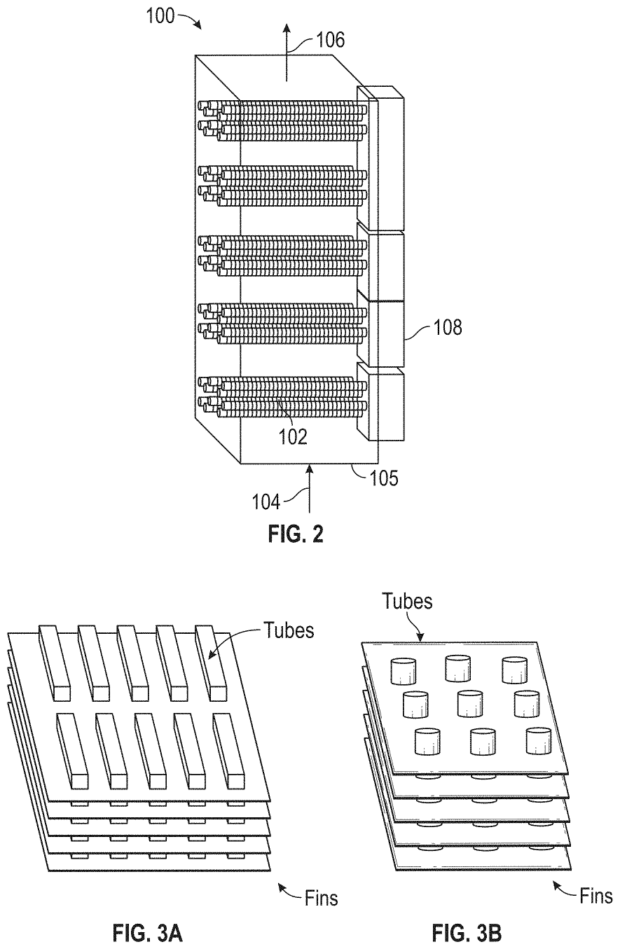

Referring now to FIG. 2, FIGS. 2 illustrates a design for the Electric Air Heater Convection Section 100, which illustrates an example of a duct design according to one or more embodiments herein. Cold air 104 flows into the bottom of the electric air heater 100, through heater duct 105, and is heated by the heating elements 102 to produce a hot air 106. The duct design has flow pattern and element pitch adjustment to optimize the heat transfer coefficient and pressure drop. The element 102 encasing from a bare sheath may be changed to a sheath with an extended surface, such as a smooth bore low-fin tube. The element design may be a NiCr resistance wire embedded in MgO for electrical isolation and encased in a low finned tube. The working voltage of the Electric Air Heater Convection Section 100 may range from 300V to 7000V, depending on the required operating temperature. The voltage required is supplied by a terminal end 108. Various embodiments of electric heaters herein may have a working voltage in a range from a lower limit of 300, 500, 700, 1000, 1250, 1500, 1750, 2000, 2250, 2500, 2750 3000, 3500, 4000, 4500, or 5000 V to an upper limit of 2500, 3000, 3500, 4000, 4500, 5000, 5500, 6000, 6500, or 7000 V, where any lower limit may be paired with any mathematically compatible upper limit.

Such design may allow for an increase in the available heat transfer area/volume by about 200% as compared to presently available small-scale electrical heaters. The design may also allow to reduce the required element length by about 40%, reducing the heater size, pressure drop, and required footprint as compared to the presently available (<5 MW) heaters. The low fin design may be capable of operating at the high temperatures required for the CATOFIN® air heater. Such fins may be similar to HPT Finned Tubes available from NEOTISS.

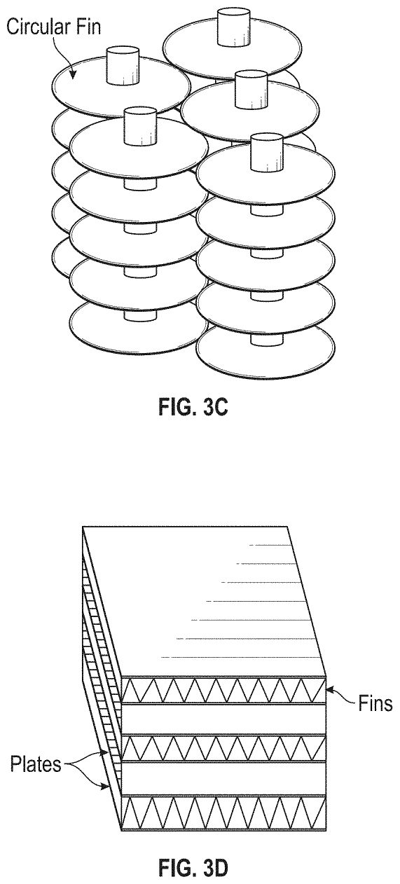

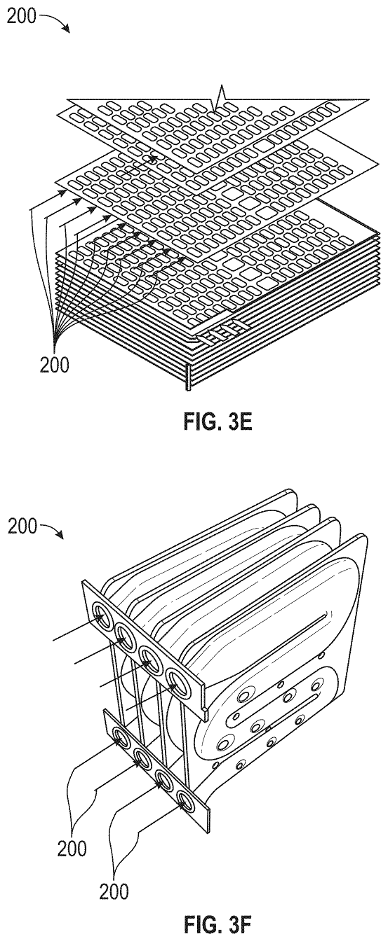

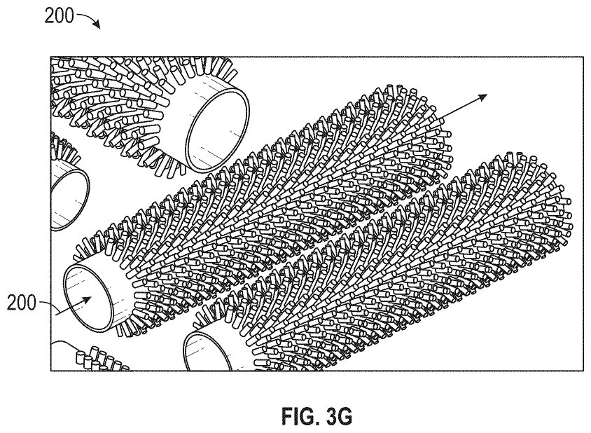

Referring now to FIGS. 3A-3G, various design considerations for the heat transfer structure are illustrated. These are various fin designs, such as tube-and-plate (A and B), circular fin (C), and fin-and-plate (D), when combined and attached to heating elements can optimize the heat transfer area per length of heating elements as described herein. As seen in (E), (F), and (G), the electrical connections 200 are used to apply current to heat the tubes in order to provide electrical heating.

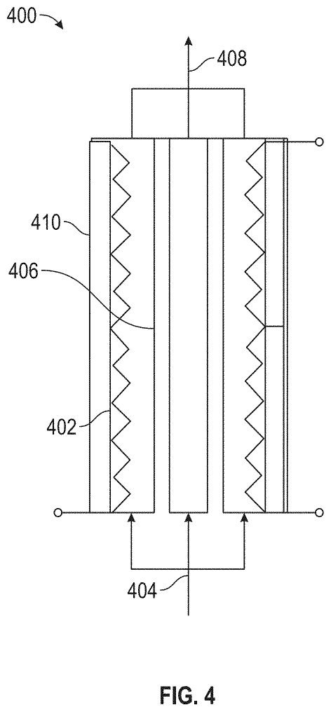

Referring now to FIG. 4, FIG. 4 illustrates a summary of an Electric Air Heater Radiant Section 400. This heater design may operate electrical elements 402 at higher temperatures, where radiant heat is the predominant heat transfer. The elements 402 may be bare, i.e., resistive wire without the metal sheath shown in FIG. 2, related to the convection section. In such embodiments, cold air 404 is fed to the bottom of the Electric Air Heater Radiant Section 400 through one or more ceramic tubes 406, which are heated by the electrical elements 402. Heated air 408 exits the top of the Electric Air Heater Radiant Section 400 at temperature sufficient to regenerate the CATOFIN reactor catalyst.

Below is a non-exhaustive list of suitable resistive wires and associated maximum operating temperatures for the Electric Air Heater Radiant Section:

NiCr alloys operating up to 1100° C.

FeCrAl alloys operating up to 1300° C.

MoSi2 operating up to 1850° C.

SiC operating up to 1600° C.

Because air is a transparent fluid, the Electric Air Heater Radiant Section 400 design may incorporate a heat sink to adsorb the radiant heat. Ceramic refractory material 410 may adsorb the radiant heat and transfer the heat to air by convection. Additional heat transfer area can be incorporated by placing a ceramic tube at the duct centerline. The electric elements 402 may be mounted to or embedded in the refractory material 410. The working voltage of the Electric Air Heater Radiant Section 400 may range from 300V to 7000V, depending on the required operating temperature. Advantages of this design are enabling the heating of air to temperatures higher than that achieved in the Electrical Air Heater Convection Section 100.

Depending upon heater requirements (temperature, capacity) and design elements (heating element material), heaters according to embodiments herein may include an electrical heating convective section (FIG. 2), an electrical heating radiant section (FIG. 4), or both.

Because large >10 MW electrical air heaters are currently commercially unavailable, the above-mentioned improvements to electrical air heaters enable to efficiently and electrically heat the regeneration air as required for the CATOFIN® process.

Several options for providing electrical heat to a process are available and can be considered according to the present disclosure. For example, more challenging processes having two-phase flow and/or coking service.

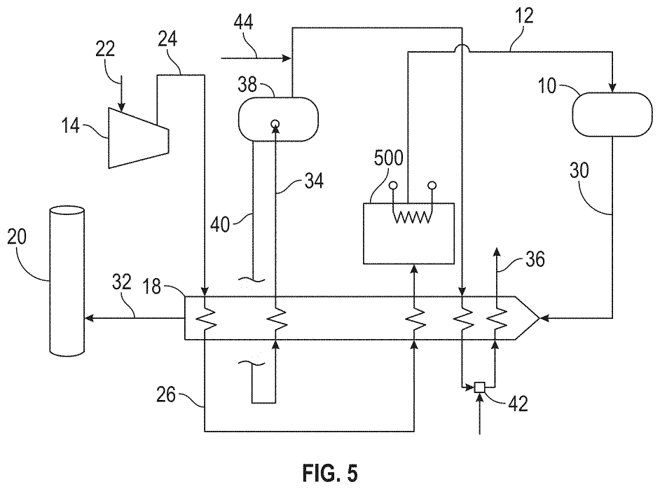

Referring now to FIG. 5, FIG. 5 illustrates an overview of the CATOFIN® Process, where similar components are represented by similar reference numerals with respect to FIG. 1.

CATOFIN® reactor 10 requires hot regeneration air 12 at about 500-800° C. to burn coke off the catalyst and to heat the catalyst bed, which drives the dehydrogenation reaction. The process consists of air compressor(s) 14, an Electrical Regeneration Air Heater 500, the CATOFIN® Reactors 10, a Waste Heat Recovery Exchanger 18, and a Stack 20. An air stream 22 is compressed to about 2.0-3.0 bar(a) to convey through the regeneration system. The compressed air 24 is then preheated in the Waste Heat Recovery Exchanger 18 to about 300-500° C. The preheated air 26 is fed back through the waste heat recovery exchanger 18 again and then heated in the Electrical Regeneration Air Heater 500 to 500-800° C., ranging in heat absorbed from 30-300 MW, depending on the plant production rate and operating conditions. The Electrical Regeneration Air Heater 500 then feeds the CATOFIN® reactors 10 where coke is burned and catalyst is heated to recover heat lost due to the endothermic dehydrogenation reaction. The heated air 30 then flows from the CATOFIN® reactors 10 to the Waste Heat Recovery Exchanger 18, where the air is cooled to about 80-120° C., producing a cool air stream 32. The cool air stream 32 then exits through the stack 20. The Waste Heat Recovery Exchanger 18 recovers energy from the CATOFIN® reactor air effluent 30, by preheating the compressed air 24, generating high pressure steam 34, and superheated high pressure steam 36. A knockout drum 38 feeds water 40 to the waste heat recovery exchanger 18 to produce mixed-phase steam via a thermosiphon design, which returns to the knockout drum 38. The high-pressure steam generated in 38 is then mixed with other high pressure steam sources 44 and sent to waste heat recovery exchanger 18 where it is superheated, then fed to desuperheater 42, then fed to waste heat recovery exchanger where it produces superheated steam 36.

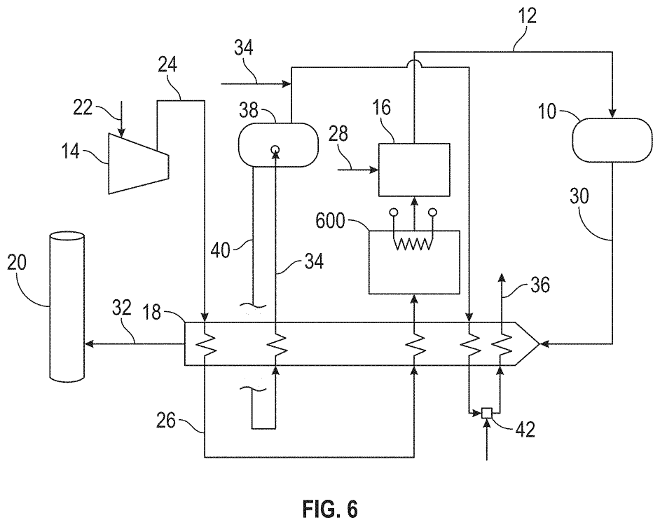

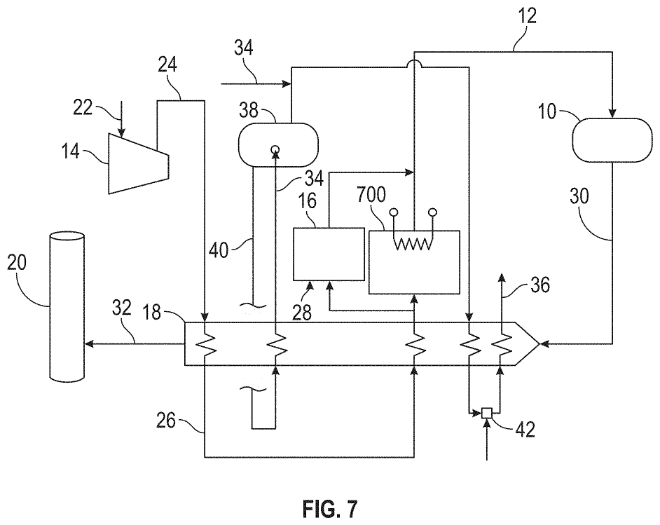

The proposed electric heater can be built in multiple units for redundancy, or use in parallel or serial with a conventional fired heater. For example, FIG. 6 illustrates the 100% Electric Air Heater 500 is replaced by Electric Heater 600 and Fired Heater 16 in series. The two heaters may be in either order. FIG. 7 illustrates the 100% Electric Air Heater 500 is replaced by Electric Heater 700 and Fired Heater 16 in parallel. In any of these embodiments, multiple electric heaters or fired heaters may be installed for increased capacity, redundancy, or both.

For the electric heater for use in CATOFIN® regeneration air system, a combination of Electric Air Heater Convection Sections, Electric Air Heater Radiant Sections, or both may be used.

In one or more embodiments, purified H₂ fuel, a byproduct of the CATOFIN® unit, may be fed to a Fired Regen Air Heater to further reduce CO₂ emissions vs. using hydrocarbon fuel.

In one or more embodiments, the system may generate steam and superheat the steam in the Waste Heat Recovery Exchanger. However, in other embodiments, the steam cycle may be eliminated to minimize the required duty of the Regeneration Air Heaters.

The heating elements can have different kinds of appearances and forms, like round wires, flat wires, twisted wires, strips, rods, rod over bend, etc. The person skilled in the art will readily understand that the form and appearance of the heating elements is not particularly limited and will be familiar with selecting the proper dimensions.

Regarding the use of low finned tubes and other finned structures in combination with heating elements, the advantages and requirements were not obvious because the scale of electrical heating industry did not warrant such designs. Converting large >10 MW industrial fired heaters to electric heaters demands a more efficient design than what was previously accepted. Furthermore, optimizing the thermal design of the electric heaters by modifying adjusting flow pattern and element pitch was not obvious because the element suppliers do not have a broad exposure to heat transfer technologies. These statements are evident from the proposed solutions in the prior art.

Use of an Electric Air Heater for CATOFIN® regeneration air heating was not obvious because it is not commercially available at the 30-300 MW scale required. Furthermore, the primary purpose of the hot air is to heat the CATOFIN® reactor to catalyze the endothermic dehydrogenation reaction. It is complex to directly, electrically heat the catalyst effectively, which is overcome by heating air electrically and alternating hydrocarbon feed and hot air flow over the catalyst bed.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A process for regenerating a catalyst in an olefin production reactor, the process comprising:
feeding a compressed, pre-heated air stream to a heating zone comprising an electrical heater;
electrically heating the compressed, pre-heated air stream in the heating zone to a temperature in the range of 500-800° C., producing a regeneration air stream;
feeding the regeneration air stream to the olefin production reactor;
regenerating the catalyst using the regeneration air, producing a hot air stream; and
feeding the hot air stream to a waste heat recovery unit configured to pre-heat a compressed air stream, producing the compressed, pre-heated air stream and a waste air stream.

2. The process of claim 1, wherein the electrical heater comprises an electrical heater capable of transferring 30 to 300 MW of energy and having a working voltage in a range from 300 V to 7000 V.

3. The process of claim 1, wherein the heating zone comprises the electrical heater and a fired heater in series, the process comprising electrically heating the compressed, pre-heated air stream in the electrical heater followed by further heating the pre-heated air stream in the fired heater.

4. The process of claim 1, wherein the heating zone comprises the electrical heater and a fired heater in series, the process comprising heating the compressed, pre-heated air stream in the fired heater followed by further heating the pre-heated air stream in the electrical heater.

5. The process of claim 1, further comprising compressing an air stream in a compressor, producing the compressed air stream.

6. The process of claim 1, further comprising removing the waste air stream to the atmosphere through a waste gas stack.

7. A system for regenerating a catalyst in an olefin production reactor, the system comprising:
a heating zone comprising an electrical heater configured for receiving a compressed, pre-heated air stream and electrically heating the compressed, pre-heated air stream to a temperature in the range of 500-800° C., producing a regeneration air stream;
a flow line configured for feeding the regeneration air stream to the olefin production reactor;
wherein the regeneration air stream regenerates the catalyst and produces a hot air stream; and
a waste heat recovery unit configured to pre-heat a compressed air stream using the hot air stream, producing the compressed, pre-heated air stream and a waste air stream.

8. The system of claim 7, wherein the electrical heater is configured to transfer 30 to 300 MW of energy and has a working voltage in a range from 300 V to 7000 V.

9. The system of claim 7, wherein the heating zone comprises the electrical heater and a fired heater in series for heating the compressed, pre-heated air stream in the electrical heater further heating the pre-heated air stream in the fired heater.

10. The system of claim 7, wherein the heating zone comprises the electrical heater and a fired heater in series for heating the compressed, pre-heated air stream in the fired heater and further heating the pre-heated air stream in the electrical heater.

11. The system of claim 7, further comprising a compressor for compressing an air stream, producing the compressed air stream.

12. The system of claim 7, further comprising a waste gas stack for removing the waste air stream to the atmosphere.

13. An electrical heater for heating an air stream, the electrical heater comprising:
one or more electrical heating elements disposed in an electrically heated radiant section;
one or more surface area increasing features attached to the one or more heating elements;
a ceramic refractory material configured for adsorbing a radiant heat from the one or more electrical heating elements and transferring the heat to the air stream by convection; and
one or more heating elements disposed in an electrically heated convention section, the electrically heated convection section located upstream of the electrically heated radiant section;
wherein the electrical heater is configured for heating the air stream to a temperature in the range of 500-800° C.

14. The electric heater of claim 13, wherein the one or more electrical heating elements disposed in the electrically heated radiant section and the one or more electrical heating elements disposed in the electrically heated convection section comprise one or more wires.

15. The electric heater of claim 14, wherein the one or more wires are made of a NiCr alloy capable of operating up to 1100° C.

16. The electric heater of claim 14, wherein the one or more wires are made of a FeCrAl alloy capable of operating up to 1300° C.

17. The electric heater of claim 14, wherein the one or more wires are made of a MoSi2 alloy capable of operating up to 1850° C.

18. The electric heater of claim 14, wherein the one or more wires are made of a SiC alloy capable of operating up to 1600° C.

19. The electrical heater of claim 13, wherein the one or more surface area increasing features are in a shape selected from the group consisting of a rectangular fin, a circulate fin, a plate, and a spike.

20. The electrical heater of claim 13, wherein the electrical heater is configured to transfer 30 to 300 MW energy and has a working voltage in a range from 300 V to 7000 V.
